(19) United States
(12) Patent Application Publication
(10) Pub. No.: US 2022/0352521 A1
(43) Pub. Date: Nov. 3, 2022

(54) INTEGRATED BATTERY ELECTRODE AND SEPARATOR

(71) Applicant: Sion Power Corporation, Tucson, AZ (US)

(72) Inventors: Yuriy V. Mikhaylik, Tucson, AZ (US); Urs Schoop, Tucson, AZ (US)

(73) Assignee: Sion Power Corporation, Tucson, AZ (US)

(21) Appl. No.: 17/730,792

(22) Filed: Apr. 27, 2022

Related U.S. Application Data
(60) Provisional application No. 63/182,654, filed on Apr. 30, 2021.

(51) Int. Cl. H01M 4/66; H01M 4/40; H01M 4/04; H01M 10/0525; H01M 4/62

(52) U.S. Cl. CPC H01M 4/661; H01M 4/405; H01M 4/0404; H01M 4/663; H01M 10/0525; H01M 4/626

(57) ABSTRACT

Some aspects of the disclosure are related to lithium batteries, and more specifically, to integrated battery electrode and separator. In some embodiments, an electrochemical cell comprises a single integrated unit comprising insulating layer, current collectors, electroactive material layers, separators, and the like. Methods of manufacturing of the integrated battery unit are disclosed herein. Some embodiments of the disclosure are also directed to an integrated anode-free electrochemical cell that lacks an anode or anode electroactive material layer. In some such embodiments, methods directed to electrical storage and use of such an anode-free electrochemical cell are disclosed herein.

### RELATED APPLICATIONS

This application claims priority to U.S. Provisional Application No. 63/182,654, filed Apr. 30, 2021, which is incorporated herein by reference in its entirety.

### TECHNICAL FIELD

The present invention relates generally to electrochemical cells, and more specifically, to electrochemical cells including an integrated electrode and separator.

### BACKGROUND

There has been considerable interest in recent years in developing high energy density rechargeable batteries with lithium-containing anodes. A typical manufacturing process for such batteries often includes multiple steps, e.g., in which individual components of the batteries are separately fabricated and later combined to form the batteries. Batteries fabricated via such a multi-step process may have certain disadvantages such as increased complexity of manufacturing and/or relatively lower specific energies and/or energy densities. Accordingly, articles and methods for reducing the complexity of manufacturing, increasing specific energy and energy density of the battery, and/or other improvements would be beneficial.

### SUMMARY

The present invention relates generally to electrochemical cells, and more specifically, to electrochemical cells including an integrated electrode and separator. The subject matter disclosed herein involves, in some cases, interrelated products, alternative solutions to a particular problem, and/or a plurality of different uses of one or more systems and/or articles.

In some aspects, an electrochemical cell is provided.

In some embodiments, the electrochemical cell comprises an insulating layer having a first side and a second side; a cathode current collector directly adjacent to the insulating layer at the first side configured to be connected to a first terminal; an anode current collector directly adjacent to the insulating layer at the second side configured to be connected to a second terminal, wherein the insulating layer prevents electronic communication and ionic communication between the cathode current collector and the anode current collector; and a cathode electroactive material layer positioned adjacent the cathode current collector at a side opposite the insulating layer.

In some aspects, a method of forming an electrochemical cell is provided.

In some embodiments, the method comprises depositing a cathode current collector on a first side of an insulating layer; depositing an anode current collector on a second side of the insulating layer opposite the first side, wherein the insulating layer is configured to inhibit electronic communication and ionic communication between the cathode current collector and the anode current collector; and depositing a cathode electroactive material layer on the cathode current collector.

In some aspects, a method of electrical energy storage and use is provided.

In some embodiments, the method comprises: in an electrochemical cell comprising a first insulating layer having a first side and a second side; a first cathode current collector directly adjacent to the first insulating layer at the first side; a first anode current collector directly adjacent to the first insulating layer at the second side, wherein the first insulating layer prevents electronic communication and ionic communication between the first cathode current collector and the first anode current collector; a first cathode electroactive material layer positioned adjacent the first cathode current collector at a side opposite the first insulating layer; an electrolyte positioned adjacent the first anode current collector at a side opposite the first insulating layer; a second cathode electroactive material layer positioned adjacent the electrolyte at a side opposite the first anode current collector; and a second cathode current collector positioned adjacent the second cathode electroactive material layer at a side opposite the electrolyte; applying a voltage during at least one period of time during charge of the electrochemical cell; and forming a first anode electroactive material layer between the electrolyte and the first anode current collector.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a perspective schematic illustration of an anode-free cell unit, in accordance with some embodiments;

FIG. 1B is a cross-sectional schematic illustration of the anode-free cell unit in FIG. 1A in the x-z plane, in accordance with some embodiments;

FIG. 1C is a cross-sectional schematic illustration of the anode-free cell unit in FIG. 1A in the y-z plane, in accordance with some embodiments;

FIG. 1D is a cross-sectional schematic illustration of an anode-free cell unit comprising additional layers in the x-z plane, in accordance with some embodiments;

FIG. 2A is a cross-sectional schematic illustration of a cell unit in the x-z plane, in accordance with some embodiments;

FIG. 2B is a cross-sectional schematic illustration of a cell unit comprising additional layers in the x-z plane, in accordance with some embodiments;

FIG. 3A is a cross-sectional schematic illustration of an electrochemical cell in the x-z plane, in accordance with some embodiments;

FIG. 3B is a cross-sectional schematic illustration of an electrochemical cell in a charged state in the x-z plane, in accordance with some embodiments;

FIG. 3C is a cross-sectional schematic illustration of an electrochemical cell during discharge in the x-z plane, in accordance with some embodiments; and

FIG. 4 is a cross-sectional schematic illustration of an intermediate product in the y-z plane during the production of a plurality of cell units, in accordance with some embodiments.

### DETAILED DESCRIPTION

Articles and methods directed to electrochemical cells comprising integrated components are disclosed herein. The electrochemical cell may comprise cell units that may comprise, for example, an insulating layer, current collectors, electroactive material layers, separators, at least two, or all, of which components are integrated to one another. In some embodiments, the electrochemical cell includes at least an integrated electrode and separator. Such an electrochemical cell may exhibit enhanced performance properties compared to certain existing electrochemical cells that do not have these integrated features. For instance, the manufacturing of an electrochemical cell having integrated components and/or as a single integrated unit may reduce the complexity of cell assembly. Additionally, the integrated electrochemical cell may advantageously exhibit enhanced specific energy and energy density compared to certain existing electrochemical cells that do not have these integrated features. These advantages may be caused in part by a reduction in the overall weight and volume of non-electroactive materials in the cell. For example, the manufacturing method described herein may allow for the production of integrated electrochemical cells comprising thinner non-electroactive material layers (e.g., insulating layer, current collectors, etc.). Furthermore, the manufacturing methods described herein may advantageously allow for the simultaneous production of a plurality of integrated electrochemical cell units, thereby reducing the complexity of manufacturing.

Some aspects of the disclosure herein are also directed to an integrated “anode-free” electrochemical cell. An “anode-free” electrochemical cell may refer to an electrochemical cell that lacks an anode (i.e., anode electroactive material layer), e.g., prior to first charge of the cell. Such a cell configuration may allow for in situ formation of an anode electroactive material layer during charge, and may advantageously enhance safety of electrochemical cells during use. For example, the lack of an anode in the cell may be associated with an absence of lithium excess, such that less amount of heat may be generated in cases of thermal runaway. Such a cell configuration may also improve the safety of the cell during handling and/or storage of the cell. Methods of electrical storage and use of such an “anode-free” electrochemical cell are also disclosed herein.

Some embodiments are directed to an integrated electrochemical cell comprising current collectors, an insulating layer, and a cathode electroactive material layer (i.e., a cathode), and optional other components, as described in more detail below.

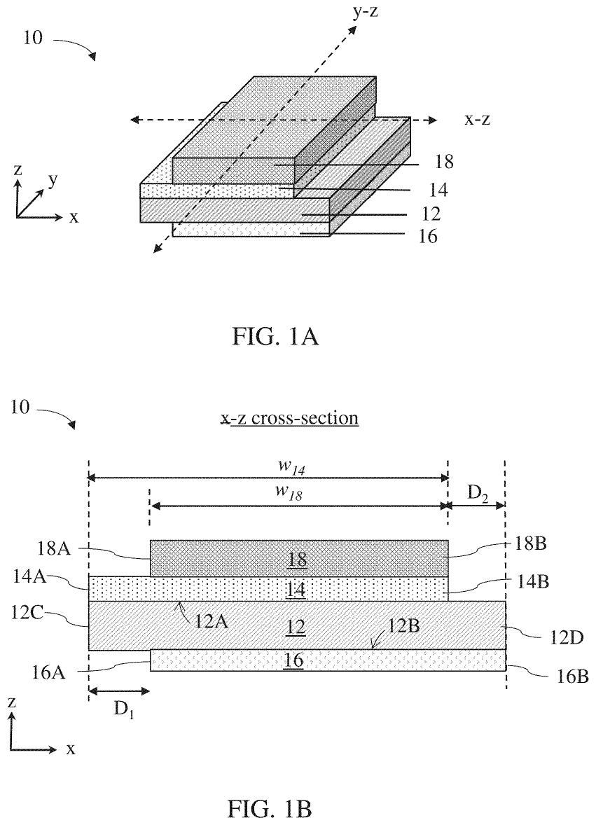

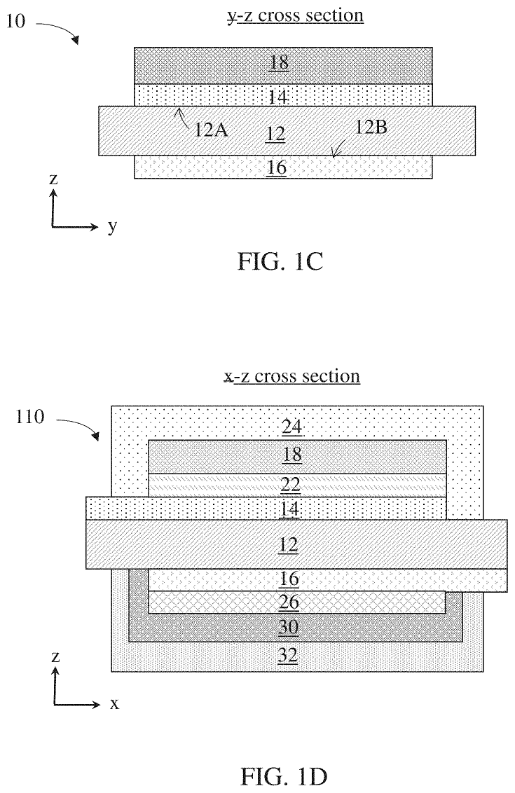

In some embodiments, the electrochemical cell comprises a cell unit comprising an insulating layer having a first side and a second side, a cathode current collector directly adjacent to the insulating layer at the first side, and an anode current collector directly adjacent to the insulating layer at the second side. FIGS. 1A-1C illustrate one such non-limiting embodiment of a cell unit 10. A first cross-sectional schematic in the x-z plane and a second cross-sectional schematic in the y-z plane of the cell unit 10 is shown in FIG. 1B and FIG. 1C, respectively. As shown illustratively in FIGS. 1B-1C, the cell unit 10 comprises an insulating layer 12 having a first side 12A and a second side 12B, a cathode current collector 14 directly adjacent to the insulating layer 12 at the first side 12A, and an anode current collector 16 directly adjacent to the insulating layer 12 at the second side 12B. It should be understood that an electrochemical cell may comprise any appropriate number of cell units described herein. For example, in one set of embodiments, the electrochemical cell comprises a single cell unit (e.g., as shown in FIGS. 1A-1C). In another set of embodiments, the electrochemical cell comprises more than one cell unit (e.g., a stack of two or more cell units).

As used herein, when a layer is referred to as being “on”, “on top of”, or “adjacent” another layer, it can be directly on, on top of, or adjacent the layer, or an intervening layer may also be present. A layer that is “directly on”, “directly adjacent” or “in contact with” another layer means that no intervening layer is present. Likewise, a layer that is positioned “between” two layers may be directly between the two layers such that no intervening layer is present, or an intervening layer may be present.

In some embodiments, two or more components of the cell unit are integrated (or integrally connected) to one another. In some embodiments, each component of the cell unit are integrated (or integrally connected) to at least one other directly adjacent component. For example, as shown in FIG. 1A, the cell unit 10 comprises components that are manufactured as a single unit, e.g., where each of the components are integrally connected to at least one other component in the cell unit. For instance, the cell unit 10 comprises an insulating layer 12 that is integrally connected to a directly adjacent cathode current collector 14 and a directly adjacent anode current collector 16. The cell unit further comprises a cathode electroactive material layer 18 that is integrally connected to the directly adjacent cathode current collector 14. This configuration differs from exiting manufacturing processes in which the above-referenced components are manufactured as separate units, e.g., a cathode, a cathode current collector, and an anode current collector which are then assembled, instead of being integrated as a single unit described herein.

As used herein, two components are integrated (or integrally connected) to one another if the two components cannot be separated manually; e.g., separation requires at least the use of tools, and/or by causing damage to at least one of the components, for example, by breaking, peeling, or separating components fastened together via adhesives or tools. By contrast, two components that are merely collated (e.g., fabricated separately and then pressed against one another) would not be integrated or integrally connected to one another. For example, a commercially available separator positioned against a commercially-available anode electroactive layer (e.g., a lithium metal foil) would not be integrated (or integrally connected) to one another. In some embodiments, components that are integrated (or integrally connected) do not become separated from each other during the course of normal use, e.g., they may be irreversibly attached to one another during the course of normal use.

In some embodiments, the insulating layer described herein prevents electronic communication and ionic communication between the cathode current collector and the anode current collector. Advantageously, the presence of such an insulating layer can prevent shorts between the cathode current collector and anode current collector during cell cycling of the cell. As described in more detail below, the current collectors may comprise any of a variety of metals. The insulating material layer may comprise any of a variety of polymers having a relatively low electronic and ionic conductivity.

In some embodiments, the current collectors described herein are positioned such that each current collector is connected to a corresponding terminal. In some such embodiments, the cathode current collector is connected to a first terminal (e.g., a positive terminal) and the anode current collector is connected to a second terminal (e.g., a negative terminal). As shown in FIG. 1B, the cathode current collector 14 may be positioned such that a side 14A of the current collector 14 is configured to connect to a positive terminal (not shown), and the anode current collector 16 may be positioned such that a side 16B opposite the side 14A is configured to connect to a negative terminal (not shown).

In some embodiments, the positions of the cathode and anode current collectors are offset to each other by a certain distance, such that the current collectors can be connected to their corresponding terminals without interference from each other. For example, as shown in FIG. 1B, the side 14A of the cathode current collector 14 may be offset from a side 16A of the anode current collector 16 by a distance D1, such that the protruded side 14A can be connected to positive terminal. Similarly, the side 16B of the anode current collector 16 may be offset from a side 14B of the cathode current collector 14 by a distance D2, such that the protruded side 16B can be connected to a negative terminal. In some such embodiments, the cathode and anode current collectors are offset to each other along a direction (e.g., x-direction) that is perpendicular to the direction (e.g., y-direction) in which the cell unit can be winded.

In some embodiments, the electrochemical cell comprises a cell unit that further comprises a cathode electroactive material layer that is positioned adjacent the cathode current collector at a side opposite the insulating layer. As shown in FIGS. 1A-1C, the electrochemical cell unit 10 comprises a cathode electroactive material layer 18 that is positioned adjacent the cathode current collector 14 at a side opposite the insulating layer 12. The cathode electroactive material layer may comprise any of a variety of cathode electroactive materials (e.g., lithium intercalation compounds) described elsewhere herein. In some embodiments, the cathode electroactive material layer may have a dimension (e.g., width) that is less than a dimension (e.g., width) of the cathode current collector. As shown in FIG. 1B, the cathode electroactive material layer 18 may have a width w₁₈ that is less than a width w₁₄ of the cathode current collector 14. Such a configuration may advantageously ensure or allow proper connection of the cathode current collector to its corresponding terminal without exposing the cathode electroactive material layer to the terminal.

While FIGS. 1A-1C show a set of embodiments in which the cathode electroactive material layer 18 is directly adjacent or in contact with the cathode current collector 14, it should be understood that not all embodiments described herein are so limiting, and in other embodiments, one or more intervening layers may be present between the cathode electroactive material layer 18 and the cathode current collector 14.

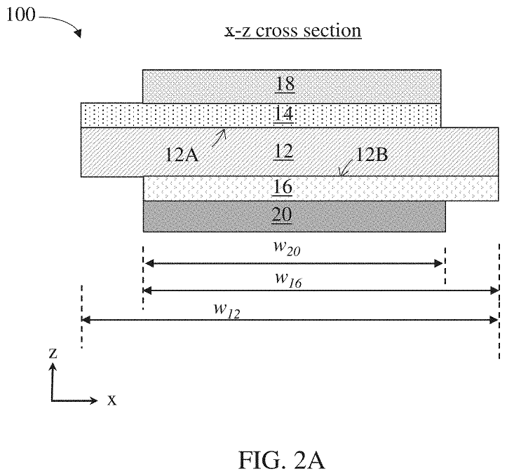

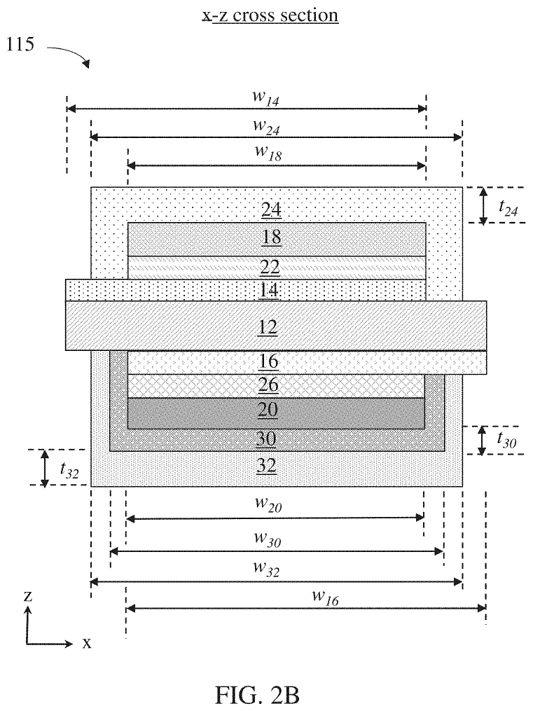

In some embodiments, additional layers may be present in the cell unit described herein. For example, in one set of embodiments, the electrochemical cell comprises a cell unit that further comprises an anode electroactive material layer comprising an anode electroactive material (e.g., lithium metal and/or lithium alloy). In some such embodiments, the electroactive material layer may be positioned adjacent the anode current collector at a side opposite the insulating layer. FIG. 2A illustrates one such non-limiting embodiment of an electrochemical cell unit 100. As shown, the electrochemical cell unit 100 comprises an anode electroactive material layer 20 positioned adjacent the anode current collector 16 at a side opposite the insulating layer 12. In some embodiments, the anode electroactive material layer is positioned directly adjacent the anode current collector at the side opposite the insulating layer. In other embodiments, one or more intervening layers may be present between the anode current collector and the anode electroactive material layer.

In some embodiments, the anode electroactive material layer has a dimension (e.g., width) that is less than a dimension (e.g., width) of the anode current collector. As shown in FIG. 2A, the anode electroactive material layer 20 may have a width w₂₀ that is less than a width w₁₆ of the anode current collector 16. Such a configuration may advantageously ensure or allow proper connection of the anode current collector to its corresponding terminal without exposing the anode electroactive material layer to the terminal.

As noted above, additional layers may be present in the cell unit. Non-limiting examples of such layers include one or more separator layers, an ion conductive layer, a precursor layer, and a primer layer. FIG. 2B illustrates one such non-limiting embodiment of a cell unit 115 comprising such layers.

In some embodiments, one or more separators may be present in the cell unit described herein. In some embodiments, the one or more separators comprise porous separator materials that may contain a non-solid electrolyte. As used herein, a non-solid electrolyte may refer to materials that are unable to withstand a static shear stress, and when a shear stress is applied, the non-solid experiences a continuing and permanent distortion. Examples of non-solids include, for example, liquids, deformable gels, and the like.

In some embodiments in which one or more separators are present, the one or more separators may be disposed adjacent (e.g., directly adjacent) an anode electroactive material layer and/or a cathode electroactive material layer. For example, in one set of embodiments, the electrochemical cell described herein comprises a cell unit comprising a first separator (i.e., a cathode-side separator) adjacent a cathode electroactive material layer. Referring to FIG. 2B, the cell unit 115 may comprise a first separator 24 adjacent the cathode electroactive material layer 18. In some instances, one or more intervening layers may be present between the first separator 24 and the cathode electroactive material layer 18.

Alternatively or additionally, an electrochemical cell may comprise a cell unit comprising a separator (i.e., a second separator such as anode-side separator) adjacent an anode electroactive material layer. As shown in FIG. 2B, the cell unit 115 may comprise a second separator 32 adjacent the anode electroactive material layer 20. In some instances, one or more intervening layers (e.g., ion conductive layer 30) may be present between the second separator 32 and the anode electroactive material layer 20. In other instances, the anode electroactive material layer 20 may be directly adjacent the second separator 32.

In some embodiments, the first separator and/or second separator comprises pores filled with an electrolyte. Each of the separators may comprise any of a variety of materials described herein. The first separator and the second separator may be the same or different. In one set of embodiments, the first separator may comprise a material that is different from the second separator. For instance, the first separator may comprise ceramic materials, and the second separator may comprise polymeric materials. In another set of embodiments, the first separator may comprise the same material as the second separator. Furthermore, in embodiments in which the electrolyte is a solid electrolyte, the one or more separators (e.g., separator 32 and/or separator 24) may comprise any of a variety of solid electrolyte. For example, in one set of embodiments, the one or more separators may be a ceramic solid state electrolyte.

In some embodiments, the one or more separators may have a configuration that substantially encapsulates (e.g., encloses) one or more layers in the cell unit. For instance, as shown illustratively in FIG. 2B, the first separator 24 substantially encapsulates the cathode electroactive material layer 18 as well as associated layers (when present). For instance, at least 1 side (e.g., at least 2 sides, or at least 3 sides, etc.) of the cathode electroactive material layer may be encapsulated by the separator. In some such embodiments, the first separator 24 has a width w₂₄ that is greater than a width w₁₈ of the cathode electroactive material layer 18. The first separator 24 may additionally have a width w₂₄ that is less than a width w₁₄ of the cathode current collector 14.

In embodiments in which a second separator is present, the second separator may substantially encapsulate (e.g., enclose) one or more layers in the cell unit. For instance, as shown in FIG. 2B, the second separator 32 substantially encapsulates the anode electroactive material layer 20 as well as associated layers (when present). For instance, at least 1 side (e.g., at least 2 sides, or at least 3 sides, etc.) of the anode electroactive material layer may be encapsulated by the separator. In some such embodiments, the second separator 32 has a width w₃₂ that is greater than a width w₂₀ of the anode electroactive material layer 20. The second separator 32 may additionally have a width w₃₂ that is less than a width w₁₆ of the anode current collector 16.

In some embodiments, a primer layer may be disposed between the cathode current collector and the cathode electroactive material layer. The presence of a primer layer may advantageously facilitate adhesion and electrical contact of the cathode electroactive material layer to the cathode current collector. As shown in FIG. 2B, the cell unit 115 may further comprise a primer layer 22 disposed between the cathode current collector 14 and the cathode electroactive material layer 18.

In some embodiments, a precursor layer (e.g., electrode precursor layer) may be present in the cell unit (e.g., an “anode free” cell unit as described herein). For example, the precursor layer may be positioned adjacent the anode current collector in the cell unit. Advantageously, the presence of a precursor layer may assist with the formation and/or deposition of the anode electroactive material layer in the electrochemical cell. For example, in one set of embodiments, a precursor layer may comprise an electrode precursor material (e.g., a metal) that is capable of reacting or alloying with a lithium to form an anode electroactive material layer comprising lithium metal and/or lithium metal alloy.

As shown in FIG. 2B, the cell unit 115 may comprise a precursor layer 26 positioned adjacent the anode current collector 16. As mentioned, the precursor layer 26 may function as a substrate that assist with the deposition and formation of an anode electroactive material layer 20. While FIG. 2B show a set of embodiments in which the precursor layer 26 is a layer separate from the anode electroactive material layer, it should be understood that not all embodiments described herein are so limiting, and in other embodiments, the precursor layer may form a part of the anode electroactive material layer. In some embodiments, at least a portion of the precursor layer forms an alloy with lithium metal during and/or after forming an anode electroactive material layer.

In some embodiments, the electrochemical cell may comprise a cell unit that further comprise an ion conductive layer. In some such embodiments, the ion conductive layer may be positioned adjacent the anode electroactive material layer. As shown in FIG. 2B, the cell unit 115 further comprises an ion conductive layer 30 positioned adjacent the anode electroactive material layer 20. In some cases, the ion conductive layer can provide, at least, one or more of the following features: (1) protection of an electrode from one or more components of an electrolyte that can react with or otherwise hasten the demise of (shorten the cycle life of) the electrode and/or overall device, (2) control over dissolution of anode material into electrolyte (e.g., reduction of lithium to lithium ion), and re-plating of electrode material from the electrolyte (e.g., oxidation of lithium ion to lithium metal), at the anode, and/or (3) control of desirable passage of components from the electrode to the electrolyte (e.g., lithium ion) while inhibiting passage of undesirable components from the electrolyte to the electrode that can damage the electrode. In some embodiments, the ion conductive layer is substantially non-electrically conductive.

The integrated electrochemical cells comprising one or more cell units described herein (e.g., FIGS. 1A-2B) may allow for a relatively simple and efficient cell assembling process. In some embodiments in which the one or more separators are integrated into a cell unit (e.g., FIG. 2B), fewer assembling steps are needed to assemble the cell unit into the electrochemical cell. In some embodiments in which the cell unit does not include the one or more separators (e.g., as shown in FIG. 1A or FIG. 2A), the cell units can be assembled with one or more free standing separators to form the electrochemical cell.

The integrated electrochemical cell described herein may advantageously have a relatively high specific energy and energy density compared to electrochemical cells manufactured using certain existing methods. These advantages may be caused in part by a reduction in the thickness of non-electroactive material layers within the cell. As described in more detail below, the manufacturing methods described herein may allow for deposition of non-electroactive material layers (e.g., insulating layer, cathode current collector, anode current collector) having reduced thickness and weight.

While some embodiments are directed to an electrochemical cell comprising a cell unit (e.g., cell unit 100 FIG. 2A) that comprises an anode electroactive material layer 20, it should be understood that not all embodiments described herein are so limiting, and in other embodiments, the electrochemical cell comprises a cell unit that does not include an anode electroactive material layer 20 (e.g., prior to charge). For example, in one set of embodiments, an anode-free electrochemical cell, i.e., an electrochemical cell manufactured without an anode electroactive material layer (e.g., prior to charge), comprising one or more anode-free cell units is disclosed herein. An example of such embodiment is shown in FIGS. 1A-1C. As shown in FIGS. 1A-1C, the cell unit 10 (e.g., an anode-free cell unit) does not include an anode electroactive material layer, e.g., such as the anode electroactive material layer 20 shown in FIG. 2A.

The anode-free electrochemical cell may comprise an anode-free cell unit that further comprise one or more additional layers described above with respective to FIG. 2B, e.g., such as a primer layer, a precursor layer, one or more separators layers, and/or an ion conductive layer. FIG. 1D shows an example of one such embodiment. As shown, the anode-free cell unit 110 comprises additional layers similar to those shown in cell unit 115 in FIG. 2B, e.g., which includes a primer layer 22, a first separator 24, a precursor layer 26, an ion conductive layer 30, and a second separator 32. For instance, as shown in FIG. 1D, the cell unit 110 may comprise a first separator 24 adjacent the cathode electroactive material layer 18 and/or a second separator 32 adjacent the anode current collector 16. In some instances, an intervening ion conductive layer 30 and/or precursor layer 26 may be positioned between the second separator 32 and the anode current collector layer 16. In some cases, an intervening primer layer 22 may be disposed between the cathode current collector 14 and the cathode electroactive material layer 18.

The use of an integrated anode-free electrochemical cell comprising one or more anode-free cell units (i.e., cell units that lack anode electroactive material layer(s)) (e.g., as shown in FIGS. 1A-1D) may advantageously allow electrochemical cells, or portions thereof, to have decreased thickness and weight compared to an otherwise-identical cell having an anode electroactive material layer (e.g., prior to first charge). Furthermore, an integrated anode-free electrochemical cell may also be associated with a reduction in lithium excess, as well as reduction in amount of heat generated during use (e.g., or during thermal runaway).

In some embodiments, a method of electrical energy storage and use related to an anode-free electrochemical cell is disclosed herein. In some such embodiments, as described in more detail below, an anode electroactive material layer may be formed in situ upon cycling (e.g., discharging) of the anode-free electrochemical cell.

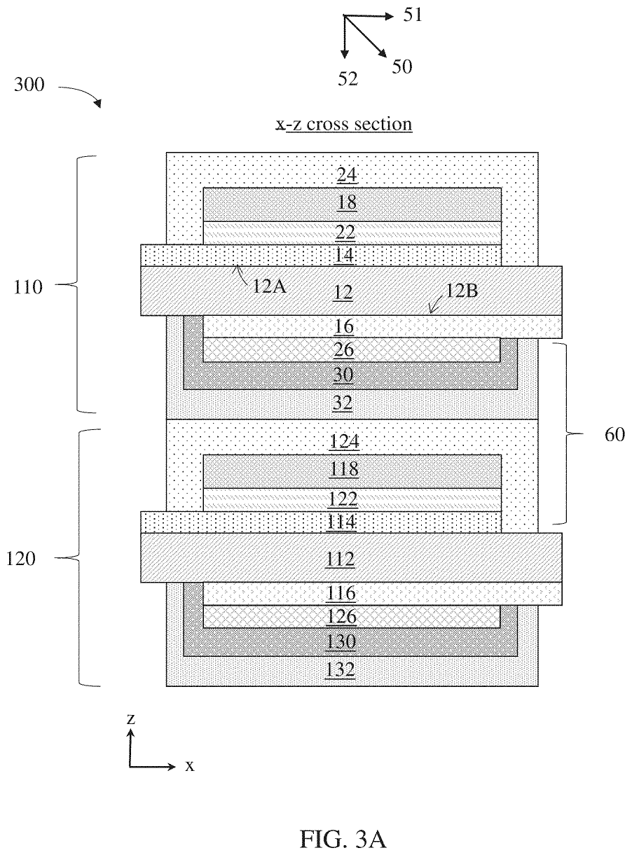

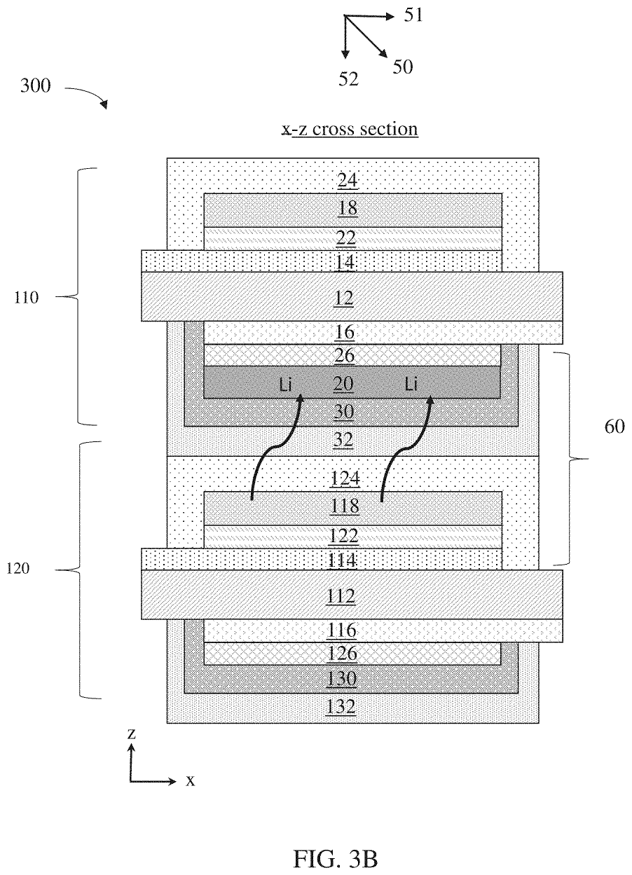

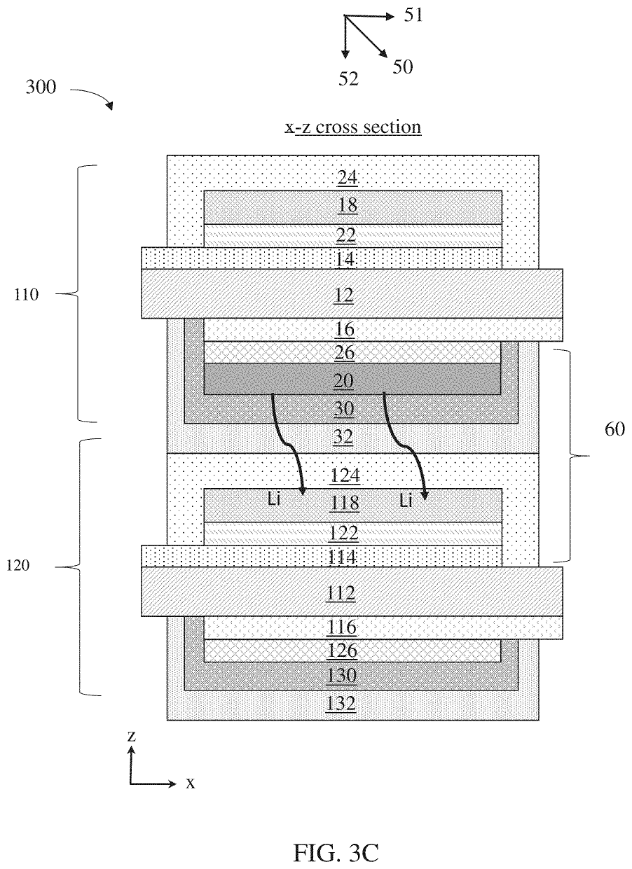

Some aspects of the disclosure are directed to a method of electrical energy storage and use of an anode-free electrochemical cell comprising one or more anode-free cell units described herein. In some such embodiments, the anode-free electrochemical cell has the configuration of a winded anode-free cell unit or is a stack of at least two or more anode-free cell units. For example, FIG. 3A illustrates a cross-sectional schematic of a non-limiting embodiment of such an electrochemical cell 300.

In FIG. 3A, an electrochemical cell 300 may comprise a stack of two identical anode-free cell units, including a first cell unit 110 (the same cell unit as shown in FIG. 1D) and a second cell unit 120 adjacent the first cell unit 110. The cell unit 120 may be identical to the cell unit 110. For instance, in electrochemical cell 300, insulating layers 12 and 112 may be identical, cathode current collectors 14 and 114 may be identical, and anode current collectors 16 and 116 may be identical. Furthermore, optional additional layers such as primer layers 22 and 122, first separator layers 24 and 124, precursor layers 26 and 126, ion conductive layers 30 and 130, and second separator layers 32 and 132, may be identical in the cell units 110 and 120.

In some embodiments, an electrochemical cell comprises a first insulating layer having a first side and a second side, a first cathode current collector directly adjacent to the first insulating layer at the first side, and a first anode current collector directly adjacent to the first insulating layer at the second side. As shown in FIG. 3A, electrochemical cell 300 comprises a first insulating layer 12 having a first side 12A and a second side 12B, a first cathode current collector 14 directly adjacent to the first insulating layer 12 at the first side 12A, and a first anode current collector 16 directly adjacent to the first insulating layer 12 at the second side 12B. In some embodiments, the first insulating layer prevents electronic communication and ionic communication between the first cathode current collector and the first anode current collector.

In some embodiments, the electrochemical cell comprises a first cathode electroactive material layer positioned adjacent the first cathode current collector at a side opposite the first insulating layer. As shown, the electrochemical cell 300 comprises a first cathode electroactive material layer 18 positioned adjacent the first cathode current collector 14 at a side opposite the first insulating layer 12. As noted above, optional intervening layers (e.g., a first primer layer 22) may be present between the first cathode current collector 14 and the first cathode electroactive material layer 18.

In some embodiments, the electrochemical cell comprises an electrolyte positioned adjacent the first anode current collector at a side opposite the first insulating layer. As shown in FIG. 3A, the electrochemical cell 300 comprises an electrolyte 60 positioned adjacent the first anode current collector 16 at a side opposite the first insulating layer 12. The electrolyte may be positioned between the first cell unit 110 and the second cell unit 120 within the one or more separators. For instance, the electrolyte may be non-solid electrolyte that is imbibed in the pores of one or more separators located at the adjacent regions between the first and the second cell units.

As shown in FIG. 3A, the electrolyte 60 (e.g., a non-solid electrolyte) may be imbibed in the pores of separator 32 in the first cell unit 110 and/or separator 124 in the second cell unit 120. Alternatively, in embodiments in which the electrolyte is a solid electrolyte, the separator (e.g., separator 32 and/or separator 124) may comprise any of a variety of solid electrolytes as described below.

While FIG. 3A shows an embodiment in which the electrolyte is contained within two separators 32 and 124, it should be understood that in other embodiments, a single separator (instead of the two separators) comprising an electrolyte may be present between the cell units 110 and 120. For instance, in one such embodiments, two identical cell units that lack integrated separators (e.g., cell unit 10 as shown in FIG. 1B) may be stacked on top of each other, with a single free-standing separator layer assembled between the two units. In another set of embodiments, each of the two identical cell units 110 and 120 may have a single integrated separator (e.g., either separator 32 or 124), such that when one unit is stacked on top of the other unit, the single integrated separator separates the two cell units.

As noted above, optional intervening layers (e.g., precursor layer and/or ion conductive layer) may be present between the first anode current collector and the electrolyte (or separators). As shown in FIG. 3A, the electrochemical cell 300 may comprise a first precursor layer 26 and a first ion conductive layer 30 positioned between the first anode current collector 16 and the electrolyte 60 (or separator 32).

In some embodiments, the electrochemical cell comprises a second cathode electroactive material layer positioned adjacent the electrolyte at a side opposite the first anode current collector. As shown in FIG. 3A, the electrochemical cell 300 comprises a second cathode electroactive material layer 118 positioned adjacent the electrolyte 60 at a side opposite the first anode current collector 16. In some embodiments, the electrochemical cell further comprises a second cathode current collector positioned adjacent the second cathode electroactive material layer at a side opposite the electrolyte. Referring again to FIG. 3A, the electrochemical cell 300 further comprises a second cathode current collector 114 positioned adjacent the second cathode electroactive material layer 118 at a side opposite the electrolyte 60. As noted, one or more optional intervening layers (e.g., a second primer layer 122) may be present between the second cathode current collector and the second cathode electroactive material layer.

Some embodiments are directed to applying a voltage during at least one period of time during charge of the electrochemical cell. For example, as shown in FIG. 3A, the electrochemical cell 300 comprising the anode-free cell units 110 and 120 may be charged during at least one period of time by an application of a voltage (e.g., a non-zero, positive voltage) to the electrochemical cell.

In some embodiments, a first anode electroactive material layer is formed between the electrolyte and the first anode current collector in the electrochemical cell when the electrochemical cell is in a charged state. FIG. 3B illustrates one such embodiment. A shown, upon charging of the electrochemical cell 300, a first anode electroactive material layer 20 is formed between the electrolyte 60 and the first anode current collector 16. The first anode electroactive material layer may comprise lithium metal and/or lithium metal alloy.

In some embodiments, forming the first anode electroactive material layer comprises transporting lithium from the second cathode electroactive material layer during charge of the cell. As shown in FIG. 3B, lithium from the second cathode electroactive material layer 118 is transported during charge of the cell to form the first anode electroactive material layer 20. For example, in one set of embodiments, the second cathode electroactive material layer is a lithium-intercalation cathode. In some such embodiments, upon charging of the electrochemical cell, intercalated lithium from the lithium-intercalation cathode may be dissolved and transported by the electrolyte from the lithium-intercalation cathode to the first anode collector to form an anode electroactive material layer (i.e., an anode) comprising lithium metal and/or a lithium metal alloy.

In some embodiments, as noted above, the electrochemical cell may comprise a precursor layer that may assist with deposition and formation of an anode electroactive material layer during charge of the cell. As shown in FIG. 3B, the electrochemical cell 300 comprises a first precursor layer 26 disposed between the first anode current collector 16 within the first cell unit 110 and the electrolyte 60. The precursor layer may comprise any of a variety precursor material described herein that is capable of reacting or alloying with lithium. In some embodiments, forming the first anode electroactive material layer comprises reacting lithium from the second cathode electroactive material layer with a precursor material in the precursor layer during charge of the cell.

In one set of embodiments, as shown in FIG. 3B, the first anode electroactive material layer 20 is formed adjacent (e.g., directly adjacent) the first precursor layer 26 on a first side and/or second side of the precursor layer. For example, the first anode electroactive material layer 20 may be formed between the electrolyte 60 and the precursor layer 26. Alternatively or additionally, the first anode electroactive material layer may be formed between the precursor layer and the first anode current collector during charge of the cell. Alternatively or additionally, upon charging, the precursor layer may react (e.g., alloy) with the lithium to form a part of the resulting anode electroactive material layer.

In some embodiments, upon discharge of the electrochemical cell, at least a portion of the lithium within the first anode electroactive material layer may be dissolved within the electrolyte and transported back to the second cathode electroactive material layer. FIG. 3C illustrates a non-limiting example of such an embodiment. As shown, upon discharge of the electrochemical cell 300, at least a portion (or substantially all) of lithium within the first anode electroactive material layer 20 may be dissolved and transported by the electrolyte 60 to the second cathode electroactive material layer 118. Accordingly, the electrochemical cell 300 may have a configuration that lacks the first anode electroactive material layer (e.g., as shown in FIG. 3A) or has a reduced amount of the first anode electroactive material layer 20. In embodiments in which the discharge capacity is less than the charge capacity (e.g., at a particular cycle), at least a portion of the first anode electroactive material layer 20 may be retained after discharge.

It should be noted that although FIGS. 3A-3C illustrate two cell units 110 and 120, any appropriate numbers of cell units (e.g., a third unit, a fourth unit, etc.) may be present. For instance, in some embodiments, a third cell unit identical to the second cell unit 120 may be positioned beneath the second cell unit 120. In some such embodiments, upon charge, lithium may be transported from a cathode electroactive material layer in the third cell unit to the second cell unit 120 such that an anode electroactive material layer may be formed in the second cell unit 120. In some such cases, the configuration of the second cell unit 120 during charge and discharge may be identical to that of the first cell unit 110 as depicted in FIGS. 3B-3C.

While FIGS. 3A-3C show a set of embodiments in which the electrochemical cell 300 comprises a stack of two anode-free cell units, it should be understood that not all embodiments described herein are so limiting, and in other embodiments, the electrochemical cell 300 may be a single cell unit that is winded (e.g., a cylindrical cell). For example, in some such cases, FIGS. 3A-3C can be used to illustrate a cross-section of a portion of an anode-free cell unit that is winded about a center axis (e.g., x-axis). In such cases, the winded electrochemical cell 300 may comprise repetitive units as it winds about the center axis, such as a first unit 110 (from a first round of winding), a second unit 120 (from a second round of winding), and optional additional units. It should be noted that the method of electrical energy storage and use (e.g., formation of a first anode electroactive material layer 20) of the winded electrochemical cell may be identical to that of the stack cells configuration described with respect to FIGS. 3A-3B.

The electrochemical cell described herein (e.g., as shown in FIG. 3A) may comprise any appropriate number of stacked cell units (or rounds of winding of a single cell unit). In some embodiments, an electrochemical cell may have a relatively small overall thickness (as a result of its relatively thin layers), such that the electrochemical cell may have a relatively high number of cell units (or rounds of winding). In some embodiments, the electrochemical cell may comprise greater than or equal to 1, greater than or equal to 2, greater than or equal to 10, greater than or equal to 25, greater than or equal to 50, greater than or equal to 100, greater than or equal to 200, greater than or equal to 300, greater than or equal to 400, greater than or equal to 500, greater than or equal to 600, greater than or equal to 700, greater than or equal to 800, or greater than or equal to 900 cell units (or rounds of winding of a single cell unit). In some embodiments, the electrochemical cell may comprise less than or equal to 2000, less than or equal to 1000, less than or equal to 900, less than or equal to 800, less than or equal to 700, less than or equal to 600, less than or equal to 500, less than or equal to 400, less than or equal to 300, less than or equal to 200, less than or equal to 100, less than or equal to 50, less than or equal to 25, less than or equal to 10, or less than or equal to 2 cell units (or rounds of winding of a single cell unit). Combination of the above-referenced ranges are possible (e.g., greater than or equal to 1 and less than or equal to 1000, or greater than or equal to 100 and less than or equal to 1000). Other ranges are also possible.

Some embodiments are related to applying, during at least one period of time during charge and/or discharge of the electrochemical cells (e.g., first cell unit, second cell unit, etc.), an anisotropic force with a component normal to an electrode surface (e.g., an active surface) of at least one cell unit of the stacked electrochemical cell or the winded cell configuration. As mentioned above, application of such a force may reduce potentially deleterious phenomena associated with certain types of electrochemical cells (e.g., cells comprising lithium metal as an electrode active material) and improve utilization. For example, in some cases, applying an anisotropic force with a component normal to an active surface of an electrode of the electrochemical cell can reduce problems (such as surface roughening of the electrode and dendrite formation) while improving current density.

FIGS. 3A-3C depict a schematic cross-sectional illustration of a force that may be applied to the first cell unit 110 and the second cell unit 120 in the direction of arrow 50. Arrow 52 illustrates the component of force 50 that is normal to an active surface of the first cell unit 110 and/or the second cell unit 120, according to certain embodiments.

In some embodiments, a method of forming an integrated electrochemical cell comprising the one or more cell units is described herein. The cell units may be any of the cell units described in FIGS. 1A-1D (e.g., cell units 10 and 110) and/or in FIGS. 2A-2B (e.g., cell units 100 and 115).

In some embodiments, the method comprises depositing (e.g., coating) a cathode current collector on a first side of an insulating layer. As shown in FIGS. 1A-1D, the cathode current collector 14 may be deposited on the first side 12A of the insulating layer 12. In some embodiments, the method comprises depositing (e.g., coating) an anode current collector on a second side of the insulating layer opposite the first side. Referring again to FIGS. 1A-1C, the anode current collector 16 may be deposited on the second side 12B of the insulating layer 12 opposite the first side 12A. The step(s) of depositing the cathode current collector and/or anode current collector may occur via vacuum deposition. Additional methods are described elsewhere herein.

In some embodiments, depositing current collectors (e.g., cathode current collector and/or anode current collector) on the insulating layer comprises coating the insulating layer with current collector materials (e.g., metals). The coated insulating layer may be subsequently used as a substrate for deposition of electroactive materials (or any intervening layers such as primer layers). Advantageously, the use of such a coated insulating layer (e.g., metal-coated insulating layer) as the substrate for depositing electrodes (e.g., cathode and/or anode electroactive material layers) may be more cost effective compared to the use of certain existing materials (e.g., thick metal foils such as lithium metal foils) as the electrode material. In addition, the methods described herein may advantageously allow for formation of thinner layers of materials (e.g., current collectors), and thus result in cells having reduced volume and weight.

In some embodiments, the method comprises depositing (e.g., coating) a cathode electroactive material layer on the cathode current collector at a side opposite the insulating layer. As shown in FIGS. 1A-1D, the cathode electroactive material layer 18 may be deposited on the cathode current collector 14 at a side opposite the insulating layer 12.

In some embodiments, an anode electroactive material layer may be further deposited (e.g., coated) onto the cell unit 10 described in FIGS. 1A-1C. For instance, as shown in FIG. 2A, the method further comprises depositing an anode electroactive material layer 20 adjacent the anode current collector 16 at a side opposite the insulating layer 12. The step(s) of depositing the cathode electroactive material layer and/or anode electroactive material layer may occur via any of a variety of methods, including, but not limited to, vacuum deposition and/or atmospheric techniques (e.g., slurry coating, solution coating, paste coating, jet spray). Additional techniques may include thermal evaporation, sputtering, jet vapor deposition, and laser ablation.

Additionally or alternatively, one or more optional layers such as the primer layer 22, the precursor layer 26, the ion conductive layer 30, separator layers 24 and 32, may be sequentially deposited in the order necessary to form the cell units illustrated in FIG. 1D or 2B. For instance, in one set of embodiments, one or more separators may be deposited adjacent the cathode electroactive material layer and/or anode electroactive material layer via any appropriate methods (e.g., vacuum deposition, and/or atmospheric methods described herein.). Alternatively, the one or more separators may be separate free standing separators that can be adhered to the cathode electroactive material layer and/or anode electroactive material layer via a roll-to-roll process prior to cell assembly.

Some aspects of the disclosure are directed to a method of forming a series of discrete and identical cell units described herein. The series of cell units may be a series of any of the cell units described in FIGS. 1A-1D and FIGS. 2A-2B.

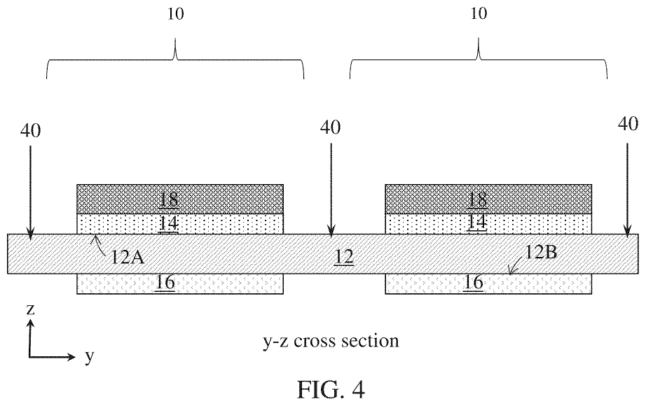

FIG. 4 illustrates a non-limiting embodiment of a method for forming a plurality of cell units (e.g., a plurality of the cell units 10 in FIGS. 1A-1C). As shown, a series of discrete patches of cathode current collectors 14 may be simultaneously or sequentially deposited (e.g., coated) on a first side 12 of the insulating layer 12. The insulating layer may be a continuous piece of insulating layer that has any of a variety of lengths. In some cases, a series of discrete patches of anode current collectors 16 may be simultaneously or sequentially deposited (e.g., coated) on the second side 12B of the insulating layer 12 opposite the first side 12A. In some cases, a series of discrete patches of the cathode electroactive material layer 18 may be simultaneously or sequentially deposited (e.g., coated) on the cathode current collector 14. Any appropriate methods of deposition described herein (e.g., vacuum deposition) may be used to deposit the patches. In some cases, a mask may be used to assist with the formation of the patches. Accordingly, as shown in FIG. 4, two identical and interconnected cell units 10 sharing the same insulating layer 12 may be formed. As such, a series of discrete and identical unit patches of cell units may be formed, all having a common insulating layer.

In some embodiments, forming a series of discrete and identical cell units comprises separating (e.g., cutting) the interconnected cell units from each other. For instance, as shown in FIG. 4, the insulating layer 12 may be separated at a location 40 between the two interconnected cell units, thus producing two separated, identical cell units 10. By separating the units at a location on the insulating layer at a non-conductive region between the units, the other conductive layers (e.g., current collectors, electroactive materials layers) remain unaffected or undamaged. Accordingly, cell units with negligible, if any, of shorting defects and/or conductive debris may be produced. Electrochemical cells formed from such cell units may advantageously have a lower likelihood to undergo shorts during cycling, compared to electrochemical cell formed from cell units produced using certain existing methods. In some embodiments, the resulting cell unit may comprise an insulating layer (e.g., insulating layer 12 in FIG. 1C) having a larger dimension (e.g., in the y-direction) than the other conductive layers (e.g., layers 14, 16, and 18 in FIG. 1C) in the cell unit.

Although FIG. 4 shows a set of embodiments describing the formation of a series of cell units each having a configuration shown in FIG. 1. 1A-1C, it should be understood that any of the cell units described herein may be formed using the same method. For instance, in addition to the deposition of patches of the cathode current collector 14, the anode current collector 16, and the cathode electroactive material layer 18, discrete patches of the anode electroactive material layer 20 (not shown) may be deposited on the anode current collector 16 at a side opposite the insulating layer 12. The insulating layer 12 may be cut at location 40 to form two separated cell units 100 shown in FIG. 2A. Similarly, cell units comprising additional layers described herein (e.g., as shown in FIG. 1D and FIG. 2B) may be formed by the same method. To form an electrochemical cell, the resulting cell units may be either winded or stacked as shown in FIG. 3A.

As noted above, the electrochemical cell may be a winded electrochemical cell. In some embodiments, the electrochemical cell may comprise a cell unit that comprises one or more layers that are brittle. In some such embodiments, the cell unit may be wound in a direction that maintains the one or more brittle layers adjacent to or at the neutral axis of the winded cell unit. For instance, materials (e.g., ceramic materials such as ones that may be used for the separator, ones that may be used for the ion conductive layer and/or cathode electroactive materials) that have a relatively higher tolerance to compression may be positioned toward the inner radius of the winded cell unit, and materials (e.g., polymeric materials such as ones that may be used for the separator and/or metallic lithium) that have a relatively higher tolerance to tension may be positioned toward the outer radius of the winded cell unit.

FIG. 2B can be used to illustrate such an embodiment. For example, in one set of embodiments, the cell unit 115 may comprise a first separator 24 (adjacent a cathode electroactive material layer) that comprises ceramic materials or is a ceramic solid state electrolyte, and a second separator 32 (adjacent an anode electroactive material layer) that comprises polymeric materials (e.g., a polyolefin separator). To form a winded electrochemical cell, the cell unit 115 may be winded in a direction such that the second separator 32 and/or the anode electroactive material layer 20 has a radius of curvature that is larger than the radius of curvature of the first separator 24 and/or the cathode electroactive material layer 18. In some embodiments, one or more of the layers may have a particular range of thickness described herein that assist with the formation of a winded electrochemical cell (e.g., a cylindrical cell).

In some embodiments, the integrated electrochemical cell described herein may comprise certain components that provide the cell with enhanced safety properties during use. In some such embodiments, as mentioned above, the integrated electrochemical comprises a cell unit comprising an insulating layer coated with relatively thin layers of current collectors on each side (e.g., as shown in FIG. 2A). The coated insulating layer may function as a fuse in the electrochemical cell when the cell is under excessive current. For instance, the thin layers of current collector on each side of the insulating layer may disconnect from the corresponding terminals under excessive current, thereby preventing thermal runaway.

Materials for the current collector may be selected, in some cases, from metals (e.g., copper, nickel, aluminum, passivated metals, and other appropriate metals), metallized polymers, electrically conductive polymers, polymers comprising conductive particles dispersed therein, and other appropriate materials. In some embodiments, the current collector material is deposited onto the insulating layer using vacuum deposition, physical vapor deposition, chemical vapor deposition, electrochemical deposition, sputtering, doctor blading, flash evaporation, or any other appropriate deposition technique for the selected material.

In some embodiments, the cathode current collector comprises an electron conductive material comprising one or more of Al, Ti, Ni, and carbon. In some embodiments, the anode current collector described herein comprises an electron conductive material comprising one or more of Cu, Ni, Mg, Zn, and carbon.

The cathode current collectors described herein may have any of a variety of appropriate thicknesses. In some embodiments, the cathode current collectors described herein may have a smaller thickness compared to cathode current collectors fabricated via conventional manufacturing processes. In some embodiments, a cathode current collector may have a thickness of greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 1.5 microns, greater than or equal to 2.0 microns, greater than or equal to 2.5 microns, greater than or equal to 3 microns, greater than or equal to 3.5 microns, greater than or equal to 4 microns, greater than or equal to 4.5 microns, greater than or equal to 5 microns, greater than or equal to 6 microns, or greater than or equal to 7.5 microns. In some embodiments, a cathode current collector may have a thickness of less than or equal to 10 microns, less than or equal to 7.5 microns, less than or equal to 6 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.4 microns, less than or equal to 0.2 microns, or less than or equal to 0.1 microns. Combination of the above-referenced ranges are possible (e.g., greater than or equal to 0.1 microns and less than or equal to 10 microns, or greater than or equal to 0.2 microns and less than or equal to 5 microns, or greater than or equal to 0.2 microns and less than or equal to 1 micron). Other ranges are also possible.

The anode current collectors described herein may have any of a variety of appropriate thicknesses. In some embodiments, the anode current collectors described herein may have a smaller thickness compared to anode current collectors fabricated via conventional manufacturing processes. In some embodiments, an anode current collector may have a thickness of greater than or equal to 0.01 microns, greater than or equal to 0.025 microns, greater than or equal to 0.05 microns, greater than or equal to 0.1 microns, greater than or equal to 0.2 microns, greater than or equal to 0.4 microns, greater than or equal to 0.6 microns, greater than or equal to 0.8 microns, greater than or equal to 1 micron, greater than or equal to 1.5 microns, greater than or equal to 2.0 microns, greater than or equal to 2.5 microns, greater than or equal to 3 microns, greater than or equal to 3.5 microns, greater than or equal to 4 microns, greater than or equal to 4.5 microns, greater than or equal to 5 microns, or greater than or equal to 7.5 microns. In some embodiments, an anode current collector may have a thickness of less than or equal to 10 microns, less than or equal to 7.5 microns, less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.4 microns, less than or equal to 0.2 microns, less than or equal to 0.1 microns, less than or equal to 0.05 microns, or less than or equal to 0.025 microns. Combination of the above-referenced ranges are possible (e.g., greater than or equal to 0.01 microns and less than or equal to 10 microns, greater than or equal to 0.01 microns and less than or equal to 5 microns, greater than or equal to 0.2 microns and less than or equal to 5 microns, greater than or equal to 0.01 microns and less than or equal to 1 micron, or greater than or equal to 0.2 microns and less than or equal to 1 micron). Other ranges are also possible.

As mentioned above, the current collectors (e.g., cathode current collector 14 and/or anode current collector 16 as shown in FIGS. 1A-1D and FIGS. 2A-2B) may be offset from each other by distances D1 and D2. D1 and D2 may have any appropriate value, as long as these distances allow for proper connection of the current collectors to their corresponding terminals. In some embodiments, D1 and D2 may be the same or different.

The current collectors described herein (e.g., cathode current collector 14 and/or anode current collector 16 as shown in FIGS. 1A-1D and FIGS. 2A-2B) may have any of variety of width. The anode current collector may have a width that is similar to or different form the cathode current collector. In one set of embodiments, the anode current collector has a width that is similar to (e.g., identical to) that of the cathode current collector.

The insulating layer described herein may have any of a variety of appropriate thicknesses. In some embodiments, the insulating layer described herein may have a relatively small thickness. In some embodiments, an insulating layer may have a thickness of greater than or equal to 0.1 microns, greater than or equal to 0.25 microns, greater than or equal to 0.5 microns, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, greater than or equal to 5 microns, greater than or equal to 6 microns, greater than or equal to 8 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, or greater than or equal to 45 microns. In some embodiments, an insulating layer may have a thickness of less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 8 microns, less than or equal to 6 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, less than or equal to 0.5 microns, or less than or equal to 0.25 microns. Combination of the above-referenced ranges are possible (e.g., greater than or equal to 0.1 microns and less than or equal to 50 microns, greater than or equal to 4 microns and less than or equal to 50 microns, greater than or equal to 0.1 microns and less than or equal to 10 microns, or greater than or equal to 0.1 microns and less than or equal to 4 microns). Other ranges are also possible.

The insulating layer may have any of a variety of appropriate widths. In some embodiments, the insulating layer has a width w₁₂ that is greater any of the widths of any of the adjacent layers and components (e.g., as shown in FIGS. 2A-2B).

The insulating layer may comprise any of a variety of insulating materials (e.g., polymers) having both a low electronic conductivity and ionic conductivity. Non-limiting examples of insulating polymers include, but are not limited to polyethylene terephthalate, polyester, polyimide, polysulfone, polyurethane, derivatives or combination thereof. Additional examples include any appropriate polymers having a low electronic conductivity and ionic conductivity. For instance, the polymer may have an ionic conductivity and/or electronic conductivity each of which may be independently less than or equal to 10⁻⁶ S/cm (e.g., less than or equal to 10⁻⁸ S/cm, less than or equal to 10⁻¹⁰ S/cm, less than or equal to 10⁻¹² S/cm, less than or equal to 10⁻¹⁴ S/cm, or less than or equal to 10⁻¹⁶ S/cm, less than or equal to 10⁻¹⁸ S/cm, or less than or equal to less than or equal to 10⁻²⁰ S/cm).

A cathode electroactive material layer described herein may have any of a variety of appropriate thicknesses. In some embodiments, a cathode electroactive material layer may have a thickness of greater than or equal to 1 micron, greater than or equal to 2 microns, greater than or equal to 3 microns, greater than or equal to 5 microns, greater than or equal to 10 microns, greater than or equal to 15 microns greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 55 microns, or greater than or equal to 60 microns. In some embodiments, a cathode electroactive material layer may have a thickness of less than or equal to 70 microns less than or equal to 60 microns, less than or equal to 55 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, less than or equal to 3 microns, or less than or equal to 2 microns. Combination of the above-referenced ranges are possible (e.g., greater than or equal to 1 micron and less than or equal to 60 microns, greater than or equal to 20 microns and less than or equal to 60 microns, greater than or equal to 1 micron and less than or equal to 20 microns, or greater than or equal to 1 micron and less than or equal to 10 microns). Other ranges are also possible.

The cathode electroactive material layer may have any of a variety of appropriate widths. In some embodiments, the cathode electroactive material layer may have a width that is less than the width of the anode current collector. Additionally, the cathode electroactive material layer may be positioned such that it offsets from the edges of the anode current collector. Such a configuration may advantageously allow for mitigation of excessive and non-uniform lithium buildup at the edges of the anode electrochemical material layer during charge.

As noted above, the cathode electroactive material layer comprises a cathode electroactive material. A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, Db, Sg, Bh, Hs).

In some cases, the cathode active material may be doped with one or more dopants to alter the electrical properties (e.g., electrical conductivity) of the cathode active material. Non-limiting examples of suitable dopants include aluminum, niobium, silver, and zirconium.

The cathode active material may be modified by a surface coating comprising an oxide. Non-limiting examples of surface oxide coating materials include: MgO, Al₂O₃, SiO₂, TiO₂, ZnO₂, SnO₂, and ZrO₂. Such coatings may prevent direct contact between the cathode active material and the electrolyte, thereby suppressing side reactions.

In certain embodiments, the cathode active material comprises sulfur. In some embodiments, the cathode active material comprises electroactive sulfur-containing materials. “Electroactive sulfur-containing materials,” as used herein, refers to electrode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In some embodiments, the electroactive sulfur-containing material comprises a mixture of elemental sulfur and a sulfur-containing polymer. Thus, suitable electroactive sulfur-containing materials may include, but are not limited to, elemental sulfur, sulfides or polysulfides (e.g., of alkali metals) which may be organic or inorganic, and organic materials comprising sulfur atoms and carbon atoms, which may or may not be polymeric. Suitable organic materials include, but are not limited to, those further comprising heteroatoms, conductive polymer segments, composites, and conductive polymers. In some embodiments, an electroactive sulfur-containing material within an electrode (e.g., a cathode) comprises at least 40 wt % sulfur. In some cases, the electroactive sulfur-containing material comprises at least 50 wt %, at least 75 wt %, or at least 90 wt % sulfur.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al., and PCT Publication No. WO 99/33130, each of which is incorporated herein by reference in its entirety for all purposes. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al., each of which is incorporated herein by reference in its entirety for all purposes. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al., each of which is incorporated herein by reference in its entirety for all purposes.

One or more electrodes may further comprise additional additives, such as conductive additives, binders, etc., as described in U.S. Pat. No. 9,034,421 to Mikhaylik et al.; and U.S. Patent Application Publication No. 2013/0316072, each of which is incorporated herein by reference in its entirety for all purposes.

An anode electroactive material layer described herein may have any of a variety of appropriate thicknesses. In some embodiments, an anode electroactive material layer may have a thickness of greater than or equal to 0 microns, greater than or equal to 1 micron, greater than or equal to 2 microns, greater than or equal to 3 microns, greater than or equal to 5 microns, greater than or equal to 10 microns, greater than or equal to 15 microns greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 55 microns, or greater than or equal to 60 microns. In some embodiments, an anode electroactive material layer may have a thickness of less than or equal to 70 microns less than or equal to 60 microns, less than or equal to 55 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, less than or equal to 3 microns, less than or equal to 2 microns, or less than or equal to 1 micron. Combination of the above-referenced ranges are possible (e.g., greater than or equal to 0 microns and less than or equal to 60 microns, greater than or equal to 1 micron and less than or equal to 60 microns, greater than or equal to 20 microns and less than or equal to 60 microns, or greater than or equal to 0 micron and less than or equal to 20 microns). Other ranges are also possible.

The anode electroactive material layer may have any of a variety of appropriate widths w₂₀ (e.g., as shown in FIG. 2A). For example, the anode electroactive material layer may have a width that is comparable (e.g., identical) to the width of the cathode electroactive material layer.

As noted above, the anode electroactive material layer comprises an anode electroactive (i.e., active) material. As used herein, the term “anode active material” refers to any electrochemically active species associated with the anode. For example, the anode may comprise a lithium-containing material, wherein lithium is the anode active material. A variety of anode active materials are suitable for use with the anodes of the electrochemical cells described herein, according to certain embodiments. In some embodiments, the anode active material comprises lithium (e.g., lithium metal), such as lithium foil, lithium deposited onto a conductive substrate or onto a non-conductive substrate (e.g., a release layer), and lithium alloys (e.g., lithium-aluminum alloys and lithium-tin alloys). Lithium can be contained as one film or as several films, optionally separated. Suitable lithium alloys for use in the aspects described herein can include alloys of lithium and aluminum, magnesium, silicium (silicon), indium, and/or tin. In some embodiments, the anode active material comprises lithium (e.g., lithium metal and/or a lithium metal alloy) during at least a portion of or during all of a charging and/or discharging process of the electrochemical cell. In some embodiments, the anode active material comprises lithium during a portion of a charging and/or discharging process of the electrochemical cell, but is free of lithium metal and/or a lithium metal alloy at a completion of a discharging process.

In some embodiments, the anode active material contains at least 50 wt % lithium. In some cases, the anode active material contains at least 75 wt %, at least 90 wt %, at least 95 wt %, or at least 99 wt % lithium. In some embodiments, the lithium may be in the form of lithium metal.

In some embodiments, the anode is an electrode from which lithium ions are liberated during discharge and into which the lithium ions are integrated (e.g., intercalated) during charge. In some embodiments, the anode active material is a lithium intercalation compound (e.g., a compound that is capable of reversibly inserting lithium ions at lattice sites and/or interstitial sites). In some embodiments, the anode active material comprises carbon. In certain cases, the anode active material is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may be present between one or more sheets in some cases. In some cases, the carbon-comprising anode active material is or comprises coke (e.g., petroleum coke). In certain embodiments, the anode active material comprises silicon, lithium, and/or any alloys of combinations thereof. In certain embodiments, the anode active material comprises lithium titanate (Li4Ti5O12, also referred to as “LTO”), tin-cobalt oxide, or any combinations thereof.

Methods for depositing an anode electroactive material layer or a negative electrode material (e.g., an alkali metal anode such as lithium) onto a substrate may include methods such as vacuum deposition, thermal evaporation, sputtering, jet vapor deposition, and laser ablation. Alternatively, where the anode comprises a lithium foil, or a lithium foil and a substrate, these can be laminated together by a lamination process as known in the art to form an anode.

The one or more separators described herein may have any of a variety of appropriate thicknesses. In embodiments in which a first separator (e.g., a cathode-side separator 24 as shown in FIG. 2B) and/or second separator (e.g., an anode-side separator 32 as shown in FIG. 2B) is present, the first separator and/or the second separator may have a thickness (e.g., t₂₄ for first separator, t₃₂ for second separator) of greater than or equal to 1 micron, greater than or equal to 2 microns, greater than or equal to 3 microns, greater than or equal to 5 microns, greater than or equal to 10 microns, greater than or equal to 15 microns greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, or greater than or equal to 80 microns. In some embodiments, the first separator and/or the second separator may have a thickness (e.g., t₂₄ for first separator, t₃₂ for second separator) of less than or equal to 100 microns less than or equal to 80 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 5 microns, less than or equal to 3 microns, or less than or equal to 2 microns. Combination of the above-referenced ranges are possible (e.g., greater than or equal to 1 micron and less than or equal to 100 microns). Other ranges are also possible.

As described herein, in some embodiments, an electrochemical cell includes a separator. The separator generally comprises a polymeric material (e.g., polymeric material that does or does not swell upon exposure to electrolyte). In some embodiments, the separator is located between the electrolyte and an electrode (e.g., between the electrolyte and a first electrode, between the electrolyte and a second electrode, between the electrolyte and an anode, or between the electrolyte and a cathode).

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A separator can be made of a variety of materials. The separator may be polymeric in some instances, or formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(e-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(e-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

A separator can be coated by various materials (e.g. ceramics). In some embodiments, a separator is a ceramic coated separator. Non-limiting examples of ceramic include alumina, boehmite, and/or silica. In some embodiments, a separator comprising a polymeric material described previously (e.g., polyolefin) may be coated by a ceramic described herein.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee.

Solid electrolytes and gel electrolytes may also function as a separator in addition to their electrolyte function. In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In addition to electrolyte solvents, gelling agents, and polymers as known in the art for forming electrolytes, the electrolyte may further comprise one or more ionic electrolyte salts, also as known in the art, to increase the ionic conductivity.

A primer layer may comprise any of a variety of appropriate materials described herein. For example, in one set of embodiments, a primer layer comprises binders and/or electronically conductive additives.

A primer layer may have any of a variety of appropriate dimensions (e.g., thickness and/or width). For instance, as shown in FIG. 2B, the primer layer 22 may have a width that is similar to (e.g., identical to) the width w₁₈ of the cathode electroactive material layer 18. A precursor layer may comprise any of a variety of appropriate active electrode species (e.g., metals) that can assist with the formation of an anode electroactive material layer upon charge. For instance, it may act as a seed layer for the deposition of lithium metal adjacent the precursor layer.

In some embodiments, a precursor layer comprises a metal. In other cases, a precursor layer comprises a semiconductor. For example, in one set of embodiments, a precursor comprises one or more metals selected from one or more of Sn, Pb, intermetallic compounds, transition metal nitrides, transition metal oxides, transition metal sulfides, and transition metal halogenides. In some embodiments, the precursor layer can form an alloy with lithium metal. Additional materials that may be suitable for use in a precursor layer include, for example, a Group 1-17 element, a Group 2-14 element, or a Group 2, 10, 11, 12, 13, 14, 15 element. Suitable elements from Group 2 of the Periodic Table may include beryllium, magnesium, calcium, strontium, and barium. Suitable elements from Group 10 may include, for example, nickel, palladium, or platinum. Suitable elements from Group 11 may include, for example, copper, silver, or gold. Suitable elements from Group 12 may include, for example, zinc, cadmium, or mercury. Elements from Group 13 that may be used in the present invention may include, for example, boron, aluminum, gallium, indium, or thallium. Elements from Group 14 that may be used in the present invention may include, for example, carbon, silicon, germanium, tin, or lead. Elements from Group 15 that may be used in the present invention may include, for example, nitrogen, phosphorus, or bismuth. In some cases, the precursor layer comprises Al, Mg, Zn, or Si.

Where a precursor layer comprises a metal, it is to be understood that one or more metals can be used. Similarly, where a precursor layer comprises a semiconductor, one or more semiconducting materials can be used. Additionally, metals and semiconductors can be mixed. That is, a precursor layer can be a single metal, a single semiconductor, or one or more metals or one or more semiconductors mixed. Non-limiting examples of suitable metals are listed above, and suitable components of semiconductors are listed above. Those of ordinary skill in the art are well aware of semiconductors that can be formed from one or more of the elements listed above, or other elements.

In some cases, where a precursor layer is present and alloys with lithium, the alloying material (which may include a material suitable for use in a precursor layer) may be present in the electroactive layer in an amount greater than 25 ppm, 50 ppm, 100 ppm, 200 ppm, 300 ppm, 400 ppm or 500 ppm, but less than or equal to 1 wt %, 2 wt %, 5 wt %, 10 wt %, 12 wt %, 15 wt %, or 20 wt % of the electroactive layer. As used herein, “wt % of the electroactive layer” means percent by total weight of the electroactive layer itself, absent current collector, protective structure, electrolyte and other materials.

It should be appreciated that in some embodiments, a precursor layer may be present in an electrode or an electrochemical cell, but does not alloy with the electroactive material during formation and/or use of the electrode or cell. In other embodiments, the precursor layer may be designed to intercalate ions of the electroactive material. Non-limiting examples of suitable materials that may intercalate ions of an electroactive material (e.g., alkaline metal ions) include carbon (e.g., graphite), titanium sulfide, and iron sulfide. In some cases, a precursor layer comprises silicon and/or germanium.

In other embodiments, a precursor layer includes a layer of lithium. The use of a lithium layer positioned between the current collector and the protective structure may be used as a seed layer to facilitate the formation of an electroactive layer. For instance, under certain conditions, the use of an intervening lithium layer can result in the formation of a smooth electroactive lithium layer. It should be appreciated that in such embodiments, the precursor layer, although it may comprise lithium, is not used as an electroactive layer itself. For instance, the thickness of the precursor layer may be such that it is unsuitable for use as an electroactive layer, but is suitable for use in an electrode or electrochemical cell assembled in a discharged state (e.g., as a seed layer). In some such embodiments, for example, the precursor layer is present in an amount such that the material participates in less than 100%, less than 80%, less than 60%, less than 40%, less than 20%, less than 10%, less than 5%, less than 2%, or less than 1% of a full discharge of the electrochemical cell.

As noted above, lithium transported from a cathode electroactive material layer may react with a metal from the precursor layer to form an anode electroactive material layer. In some embodiments, lithium may intercalate with the precursor material in the precursor layer, thus converting the precursor layer into an anode electroactive material layer. In one set of embodiments, an electrochemically active electrode precursor may be provided, comprising a carbon-based electrically-conductive material and an active electrode species. For example, the electrode precursor may include a porous carbon substrate and an active electrode species within the substrate. Material may be removed from the electrode precursor essentially uniformly to form the electrode. As used herein, removing material “essentially uniformly” from the electrode precursor means that material is removed uniformly throughout the bulk of the electrode precursor.

A precursor layer may have any of a variety of appropriate dimensions (e.g., thickness and/or width). For instance, as shown in FIG. 2B, the precursor layer 26 may have a width that is similar to (e.g., identical to) the width w₂₀ of the anode electroactive material layer 20.

The precursor layer positioned adjacent the current collector may have any of a variety of appropriate thicknesses. For instance, the thickness of the precursor layer may be less than 5 microns, less than or equal to 4.5 microns, less than or equal to 4 microns, less than or equal to 3.5 microns, less than or equal to 2 microns, less than or equal to 2.5 microns, less than or equal to 2 microns, less than 1.8 microns, less than or equal to 1.5 microns, less than or equal to 1 micron, less than or equal to 800 nm, less than or equal to 600 nm, less than or equal to 400 nm, less than or equal to 300 nm, less than or equal to 200 nm, less than or equal to 100 nm, less than or equal to 50 nm, less than or equal to 40 nm, less than or equal to 30 nm, less than or equal to 20 nm, less than or equal to 10 nm, or less than or equal to 5 nm. In some embodiments, the thickness of the precursor layer may be greater than or equal to 5 nm, greater than or equal to 10 nm, greater than or equal to 20 nm, greater than or equal to 30 nm, greater than or equal to 40 nm, greater than or equal to 50 nm, greater than or equal to 100 nm, greater than or equal to 200 nm, greater than or equal to 300 nm, greater than or equal to 400 nm, greater than or equal to 600 nm, greater than or equal to 800 nm, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, or greater than or equal to 4.5 microns. Combinations of the above-referenced ranges are also possible (greater than or equal to 1 nm and less than or equal to 5 microns, or greater than or equal to 1 nm and less than or equal to 2 microns). Other ranges of thicknesses are also possible.

In one set of embodiments, the ion conductive layer (e.g., single-ion conductive layer) may have a shape or structure that protects the anode electroactive material layer from one or more undesirable components (within the electrolyte) within the electrochemical cell. In some such embodiments, the anode electroactive material layer may be at least partially encapsulated by the ion conductive layer. As shown in FIG. 2B, the anode electroactive material layer 20 is at least partially encapsulated the ion conductive layer 30. It should be understood that in some embodiments, more than one ion conductive layer may be present. For example, the electrochemical cell may comprise a protective structure comprising one or more such ion conductive layers.

The ion conductive layer described herein may have any of a variety of appropriate thicknesses. In some embodiments, an ion conductive layer (e.g., 30 as shown in FIG. 2B) may have a thickness (e.g., t₃₀ in FIG. 2B) of greater than or equal to 0.001 microns, greater than or equal to 0.01 microns, greater than or equal to 0.1 microns, greater than or equal to 0.5 microns, greater than or equal to 1 micron, greater than or equal to 2 microns, greater than or equal to 4 microns, greater than or equal to 6 microns, or greater than or equal to 8 microns. In some embodiments, an ion conductive layer may have a thickness of less than or equal to 10 microns, less than or equal to 8 microns, less than or equal to 6 microns, less than or equal to 4 microns, less than or equal to 2 microns, less than or equal to 1 micron, less than or equal to 0.5 microns, less than or equal to 0.1 microns, or less than or equal to 0.01 microns. Combination of the above-referenced ranges are possible (e.g., greater than or equal to 0.001 microns and less than or equal to 10 microns, greater than or equal to 0.01 microns and less than or equal to 5 microns, or greater than or equal to 0.1 microns and less than or equal to 1 micron). Other ranges are also possible.

The ion conductive layer may have any of a variety of appropriate widths. In some embodiments, as shown in FIG. 2B, the ion conductive layer 30 may have a width w₃₀ that is larger than a width w₂₀ of the anode electroactive material layer 20, such that the anode electroactive material layer is at least partially encapsulated (e.g., enclosed, surrounded, etc.) by the ion conductive layer.

In some embodiments, the ion conductive layer may be formed by any of a variety of appropriate methods and comprise any of a variety of appropriate materials. Some methods relate to forming an ion conductive layer by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, an ion conductive layer described herein comprises an inorganic material. The inorganic material(s) may comprise a ceramic material (e.g., a glass, a glassy-ceramic material). The inorganic material(s) may be crystalline, amorphous, or partially crystalline and partially amorphous. In some embodiments, the ion conductive layer comprises LiₓMP_{y}S_{z}. For such inorganic materials, x, y, and z may be integers (e.g., integers less than 32) and/or M may comprise Sn, Ge, and/or Si. By way of example, the inorganic material may comprise Li₂₂SiP₂S₁₈, Li₂₄MP₂S₁₉ (e.g., Li₂₄SiP₂S₁₉), LiMP₂S₁₂ (e.g., where M=Sn, Ge, Si), and/or LiSiPS. Even further examples of suitable inorganic materials include garnets, sulfides, phosphates, perovskites, anti-perovskites, other ion conductive inorganic materials and/or mixtures thereof. When LiₓMP_{y}S_{z} particles are employed in an ion conductive layer thereof, they may be formed, for example, by using raw components Li₂S, SiS₂ and P₂S₅ (or alternatively Li₂S, Si, S and P₂S₅).

In some embodiments, an ion conductive layer described herein comprises an oxide, nitride, and/or oxynitride of lithium, aluminum, silicon, zinc, tin, vanadium, zirconium, magnesium, and/or indium, and/or an alloy thereof. Non-limiting examples of suitable oxides include Li₂O, LiO, LiO₂, LiRO₂ where R is a rare earth metal (e.g., lithium lanthanum oxides), lithium titanium oxides, Al₂O₃, ZrO₂, SiO₂, CeO₂, and Al₂TiO₅. Further examples of suitable materials that may be employed include lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium fluorides (e.g., LiF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium borosulfides, lithium aluminosulfides, lithium phosphosulfides, oxy-sulfides (e.g., lithium oxy-sulfides), and/or combinations thereof. In some embodiments, the plurality of particles comprises Li—Al—Ti—PO₄ (LATP).

In some embodiments, an ion conductive layer described herein comprises a plurality of particles that are at least partially fused together and/or that have a structure indicative of particles deposited by aerosol deposition comprises an inorganic material. For instance, a plurality of particles that are at least partially fused together and/or that have a structure indicative of particles deposited by aerosol deposition may be formed of an inorganic material. In some embodiments, a plurality of particles that are at least partially fused together and/or that have a structure indicative of particles deposited by aerosol deposition comprise two or more types of inorganic materials. The plurality of particles may comprise any appropriate materials described above.

In some embodiments, an ion conductive layer described herein may comprise pores with an average size (e.g., an average size that is advantageous) of greater than or equal to 10 nm, greater than or equal to 15 nm, greater than or equal to 20 nm, greater than or equal to 30 nm, greater than or equal to 50 nm, greater than or equal to 75 nm, greater than or equal to 100 nm, greater than or equal to 150 nm, greater than or equal to 200 nm, greater than or equal to 300 nm, greater than or equal to 500 nm, or greater than or equal to 750 nm. The average pore size of the ion conductive layer may be less than or equal to 1 micron, less than or equal to 750 nm, less than or equal to 500 nm, less than or equal to 300 nm, less than or equal to 200 nm, less than or equal to 150 nm, less than or equal to 100 nm, less than or equal to 75 nm, less than or equal to 50 nm, less than or equal to 30 nm, less than or equal to 20 nm, or less than or equal to 15 nm. Combinations of the above-referenced ranges are also possible (e.g., greater than or equal to 10 nm and less than or equal to 1 micron). Other ranges are also possible. When more than one ion conductive layer is present, each ion conductive layer may independently comprise pores with an average size in one or more of the ranges above. In some embodiments, a protective layer and/or sublayer thereof comprises a polymer with an average pore size in one or more of the ranges listed above. BET surface analysis, as described, for example, in S. Brunauer, P. H. Emmett, and E. Teller, J. Am. Chem. Soc., 1938, 60, 309, which is incorporated herein by reference in its entirety, may be used to determine the average pore size of the ion conductive layer.

The electrochemical cells described herein may comprise an electrolyte. The electrolyte can function as a medium for the storage and transport of ions, and in the special case of solid electrolytes and gel electrolytes, these materials may additionally function as a separator between an anode and a cathode. Any liquid, solid, or gel material capable of storing and transporting ions may be used, so long as the material facilitates the transport of ions (e.g., lithium ions) between an anode and the cathode. The electrolyte is electronically non-conductive to prevent short circuiting between an anode and a cathode. In some embodiments, the electrolyte may comprise a non-solid electrolyte.

In some embodiments, the electrolyte comprises a fluid that can be added at any point in the fabrication process. In some cases, the electrochemical cell may be fabricated by providing a cathode and an anode, applying an anisotropic force component normal to the active surface of the anode, and subsequently adding the fluid electrolyte such that the electrolyte is in electrochemical communication with the cathode and the anode. In other cases, the fluid electrolyte may be added to the electrochemical cell prior to or simultaneously with the application of an anisotropic force component, after which the electrolyte is in electrochemical communication with the cathode and the anode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. patent application Ser. No. 12/312,764, filed May 26, 2009 and entitled “Separation of Electrolytes,” by Mikhaylik et al., which is incorporated herein by reference in its entirety.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes, for example, in lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

In one set of embodiments, the solvent comprises at least one fluorinated organic solvent. In some embodiments, a fluorinated organic solvent and/or a mixture of fluorinated organic solvent is used as the sole solvent in the electrolyte. In some embodiments, the at least one fluorinated organic solvent is selected from group of cyclic and linear fluorinated carbonates, fluorinated ethers, and fluorinated esters (e.g., fluorinated alkyl esters). For example, in one embodiment, the solvent comprises at least one fluorinated organic solvent that is selected from fluoroethylene carbonate and/or difluoroethylene carbonate. Additional non-limiting examples of fluorinated organic solvent include, but are not limited to, methyl, 2,2,2,-trifluoroethyl carbonate, 1,1,2,2,-tetrafluoroethyl 2,2,2-trifluoroethylether, 1,1,2,2-tetrafluoroethyl-2,2,3,3-tetrafluoropropylether, methyl difluoroacetate, ethyl difluoroacetate, methyl trifluoroacetate, and ethyl trifluoroacetate.

In some embodiments, the solvent further comprises at least one non-fluorinated organic solvent. In some embodiments, the at least one non-fluorinated organic solvent comprises ester-based solvents. In some embodiments, the organic solvent may comprise one or more of esters of carboxylic acids, esters of phosphoric acid, linear and cyclic ethers and acetals, esters of sulfuric acids, esters of sulfonic acids, esters formed from carboxylic acids and halogenated alcohols, and alkyl esters. In some embodiments, the at least one non-fluorinated organic solvent comprises cyclic and/or linear carbonates. In some such embodiments, the non-fluorinated solvent may comprise one or more of carbonate-based solvents selected from the group of dimethyl carbonate, diethyl carbonate, ethyl methyl carbonate, propylene carbonate, and ethylene carbonate. Additionally or alternatively, the at least one non-fluorinated organic solvent may comprise acetates (e.g., methyl acetate, ethyl acetate), alky esters (e.g, ethyl butyrate), lactones (e.g., gamma-butyrolactone), etc.

In some embodiments, the organic solvent may comprise one or more of carbonate-based solvents selected from the group of fluoroethylene carbonate, dimethyl carbonate, diethyl carbonate, ethyl methyl carbonate, propylene carbonate, and ethylene carbonate. In some embodiments, the organic solvent may comprise a mixture of fluoroethylene carbonate and dimethyl carbonate. In some embodiments, a weight ratio of fluoroethylene carbonate and dimethyl carbonate may be greater than or equal to 1:10 and less than or equal to 100:1. In some embodiments, the weight ratio is greater than or equal to 1:4 and less than or equal to 1:3. Other ranges may be possible.

In some embodiments, the electrolyte comprises at least one lithium salt. In one set of embodiments, the lithium salt may comprise one or more of lithium hexafluorophosphate (LiPF₆), lithium bis(fluorosulfonyl)imide (LiFSI), lithium perchlorate (LiClO₄), lithium hexafluoroarsenate (LiAsF₆), lithium tetrafluoroborate (LiBF₄), lithium trifluromethanesulfonate (LiCF₃SO₃), and lithium bis(trifluoromethanesulfonyl)imide (LiTFSI). Additional examples of lithium include, but are not limited to, LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, lithium bis(oxalato)borate, lithium difluoro(oxalato)borate, a salt comprising a tris(oxalato)phosphate anion (e.g., lithium tris(oxalato)phosphate), LiC(SO₂CF₃)₃, LiCF₃SO₃, LiN(SO₂F)₂, LiN(SO₂CF₃)₂, LiC(CₙF₂ₙ₊₁SO₂)₃ wherein n is an integer in the range of from 1 to 20, and (CₙF₂ₙ₊₁SO₂)mXLi with n being an integer in the range of from 1 to 20, m being 1 when X is selected from oxygen or sulfur, m being 2 when X is selected from nitrogen or phosphorus, and m being 3 when X is selected from carbon or silicon. Other electrolyte salts that may be useful include lithium polysulfides (Li2Sx), and lithium salts of organic polysulfides (LiSxR)n, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂⁻, bis (trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

As described above, in some embodiments, a force, or forces, is applied to portions of an electrochemical cell. Such application of force may reduce irregularity or roughening of an electrode surface of the cell (e.g., when lithium metal or lithium alloy anodes are employed), thereby improving performance. Electrochemical devices in which anisotropic forces are applied and methods for applying such forces are described, for example, in U.S. Pat. No. 9,105,938, issued Aug. 11, 2015, published as U.S. Patent Publication No. 2010/0035128 on Feb. 11, 2010, and entitled “Application of Force in Electrochemical Cells,” which is incorporated herein by reference in its entirety for all purposes.

In the embodiments described herein, batteries may undergo a charge/discharge cycle involving deposition of metal (e.g., lithium metal or other active material) on a surface of an anode upon charging and reaction of the metal on the anode surface, wherein the metal diffuses from the anode surface, upon discharging. The uniformity with which the metal is deposited on the anode may affect cell performance. For example, when lithium metal is removed from and/or redeposited on an anode, it may, in some cases, result in an uneven surface. For example, upon redeposition it may deposit unevenly forming a rough surface. The roughened surface may increase the amount of lithium metal available for undesired chemical reactions which may result in decreased cycling lifetime and/or poor cell performance. The application of force to the electrochemical device has been found, in accordance with certain embodiments described herein, to reduce such behavior and to improve the cycling lifetime and/or performance of the cell.

In some embodiments, the battery (e.g., a housing of the battery) is configured to apply, during at least one period of time during charge and/or discharge of the device, an anisotropic force with a component normal to an electrode active surface of one of the electrochemical cells (e.g., first electrochemical cell, second electrochemical cell).

In some embodiments, an anisotropic force with a component normal to an electrode active surface of one of the electrochemical cells (e.g., first electrochemical cell, second electrochemical cell) is applied during at least one period of time during charge and/or discharge of the battery. In some embodiments, the force is applied continuously, over one period of time, or over multiple periods of time that may vary in duration and/or frequency. The anisotropic force may be applied, in some cases, at one or more pre-determined locations, optionally distributed over an active surface of the one or more of the electrochemical cells of the battery. In some embodiments, the anisotropic force is applied uniformly over one or more active surfaces of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes certain forces applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an electrode such as an anode, is given its ordinary meaning as would be understood by those of ordinary skill in the art and includes, for example, a force which, at least in part, exerts itself in a direction substantially perpendicular to the surface. Those of ordinary skill can understand other examples of these terms, especially as applied within the description of this document.

In some embodiments, the anisotropic force can be applied such that the magnitude of the force is substantially equal in all directions within a plane defining a cross-section of the battery, but the magnitude of the forces in out-of-plane directions is substantially unequal to the magnitudes of the in-plane forces.

In one set of embodiments, batteries (e.g., housings) described herein are configured to apply, during at least one period of time during charge and/or discharge of the cell, an anisotropic force with a component normal to an electrode active surface of one of the electrochemical cells (e.g., first electrochemical cell, second electrochemical cell). Those of ordinary skill in the art will understand the meaning of this. In such an arrangement, the electrochemical cell may be formed as part of a container which applies such a force by virtue of a “load” applied during or after assembly of the cell, or applied during use of the battery as a result of expansion and/or contraction of one or more components of the battery itself.

The magnitude of the applied force is, in some embodiments, large enough to enhance the performance of the battery. An electrode active surface (e.g., anode active surface) and the anisotropic force may be, in some instances, together selected such that the anisotropic force affects surface morphology of the electrode active surface to inhibit increase in electrode active surface area through charge and discharge and wherein, in the absence of the anisotropic force but under otherwise essentially identical conditions, the electrode active surface area is increased to a greater extent through charge and discharge cycles. “Essentially identical conditions,” in this context, means conditions that are similar or identical other than the application and/or magnitude of the force. For example, otherwise identical conditions may mean a battery that is identical, but where it is not constructed (e.g., by couplings such as brackets or other connections) to apply the anisotropic force on the subject battery.

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may be under an externally-applied anisotropic force with a component defining a pressure of at least 10 kgf/cm², at least 20 kgf/cm², or more. This is because the yield stress of lithium is around 7-8 kgf/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 10 kgf/cm², at least about 20 kgf/cm², and/or up 30 kgf/cm², up to 40 kgf/cm² of externally-applied pressure, the lithium surface may become smoother with cycling when the pressing surface is smooth.

In some cases, one or more forces applied to the cell have a component that is not normal to an active surface of an anode. For example, in FIGS. 3A-3C, force 51 is not normal to electrode active surfaces of the first cell unit 110 and second cell unit 120. In one set of embodiments, the sum of the components of all applied anisotropic forces in a direction normal to any electrode active surface of the battery is larger than any sum of components in a direction that is non-normal to the electrode active surface. In some embodiments, the sum of the components of all applied anisotropic forces in a direction normal to any electrode active surface of the battery is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the electrode active surface.

In some cases, electrochemical cells may be pre-compressed before they are inserted into housings, and, upon being inserted to the house, they may expand to produce a net force on the electrochemical cells. Such an arrangement may be advantageous, for example, if the electrochemical cells are capable of withstanding relatively high variations in pressure.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21, 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1, published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1, published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1, published on Nov. 23, 2017, filed as U.S. application Ser. No. 15/599,595 on May 19, 2017, patented as U.S. Pat. No. 10,879,527 on Dec. 29, 2020 and entitled “PROTECTIVE LAYERS FOR ELECTRODES AND ELECTROCHEMICAL CELLS”; U.S. Publication No. US-2019-0088958-A1, published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1, published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1, published Jul. 13, 2017, filed as U.S. Application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1, published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1, published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1, published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1, published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1, published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1, published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1, published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1, published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1, published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical cell, comprising:
an insulating layer having a first side and a second side;
a cathode current collector directly adjacent to the insulating layer at the first side configured to be connected to a first terminal;
an anode current collector directly adjacent to the insulating layer at the second side configured to be connected to a second terminal, wherein the insulating layer prevents electronic communication and ionic communication between the cathode current collector and the anode current collector; and
a cathode electroactive material layer positioned adjacent the cathode current collector at a side opposite the insulating layer.

2. A method of forming an electrochemical cell, comprising:
depositing a cathode current collector on a first side of an insulating layer;
depositing an anode current collector on a second side of the insulating layer opposite the first side, wherein the insulating layer is configured to inhibit electronic communication and ionic communication between the cathode current collector and the anode current collector; and
depositing a cathode electroactive material layer on the cathode current collector.

3. A method of electrical energy storage and use, comprising:
in an electrochemical cell comprising:
a first insulating layer having a first side and a second side;
a first cathode current collector directly adjacent to the first insulating layer at the first side;
a first anode current collector directly adjacent to the first insulating layer at the second side, wherein the first insulating layer prevents electronic communication and ionic communication between the first cathode current collector and the first anode current collector;
a first cathode electroactive material layer positioned adjacent the first cathode current collector at a side opposite the first insulating layer;
an electrolyte positioned adjacent the first anode current collector at a side opposite the first insulating layer;
a second cathode electroactive material layer positioned adjacent the electrolyte at a side opposite the first anode current collector; and
a second cathode current collector positioned adjacent the second cathode electroactive material layer at a side opposite the electrolyte;
applying a voltage during at least one period of time during charge of the electrochemical cell; and
forming a first anode electroactive material layer between the electrolyte and the first anode current collector.

4. (canceled)

5. An electrochemical cell as in claim 1, further comprising an anode electroactive material layer positioned adjacent the anode current collector at a side opposite the insulating layer, and wherein the anode electroactive material layer comprises an anode electroactive material.

6. (canceled)

7. An electrochemical cell as in claim 1, wherein the cathode electroactive material layer has a thickness of greater than or equal to 1 micron and less than or equal to 60 microns.

8. An electrochemical cell as in claim 5, wherein the anode electroactive material layer comprises lithium metal and/or lithium alloy.

9. An electrochemical cell as in claim 1, wherein the cathode electroactive material layer is a lithium intercalation cathode.

10. An electrochemical cell as in claim 1, wherein the cathode electroactive material layer has a width that is less than a width of the cathode current collector.

11. An electrochemical cell as in claim 5, wherein the anode electroactive material layer has a width that is less than a width of the anode current collector.

12. An electrochemical cell as in claim 1, wherein the cathode current collector comprises an electron conductive material comprising one or more of Al, Ti, Ni, and carbon.

13. An electrochemical cell as in claim 1, wherein the anode current collector comprises an electron conductive material comprising one or more of Cu, Ni, Mg, Zn, and carbon.

14. An electrochemical cell as in claim 1, wherein the cathode current collector has a thickness of less than or equal to 5 microns.

15. (canceled)

16. An electrochemical cell as in claim 1, where the positions of the cathode and anode current collectors are offset to each other along a direction that is perpendicular to a direction in which the electrochemical cell is winded.

17. An electrochemical cell as in claim 1, wherein the first terminal is a positive terminal, and wherein the second terminal is a negative terminal.

18-19. (canceled)

20. An electrochemical cell as in claim 1, wherein the insulating layer has a thickness of less than or equal to 50 microns.

21-30. (canceled)

31. An electrochemical cell as in claim 1, further comprising a primer layer disposed between the cathode current collector and the cathode electroactive material layer, and wherein the primer layer comprises binders and electronically conductive additives.

32. (canceled)

33. An electrochemical cell as in claim 1, further comprising a precursor layer adjacent the anode current collector, and wherein the precursor layer comprises a precursor material that is capable of reacting or alloying with lithium to form an anode electroactive material layer.

34. (canceled)

35. An electrochemical cell as in claim 33, wherein the precursor layer comprises a metal, and wherein the metal comprises one or more of Sn, Pb, intermetallic compounds, transition metal nitrides, transition metal oxides, transition metal sulfides, and transition metal halogenides.

36. An electrochemical cell as in claim 5, further comprising an ion conductive layer positioned adjacent the anode electroactive material layer.

37-49. (canceled)

50. An electrochemical cell as in claim 5, wherein the electrochemical cell further comprises a porous separator adjacent the cathode electroactive material layer and/or the anode electroactive material layer, and wherein an electrolyte is imbibed in the pores of the separator.

51-60. (canceled)
